(19) United States
(12) Patent Application Publication
(10) Pub. No.: US 2009/0165367 A1
(43) Pub. Date: Jul. 2, 2009

(54) Fast biodiesel production from bio-substance with radio frequency heating

(76) Inventors: Yifen Wang, Auburn, AL (US); Shaoyang Liu, Auburn, AL (US); Steven E. Taylor, Auburn, AL (US)

Correspondence Address: HAVERSTOCK & OWENS LLP, 162 N WOLFE ROAD, SUNNYVALE, CA, 94086, US

(21) Appl. No.: 12/317,368

(22) Filed: Dec. 19, 2008

Related U.S. Application Data
(60) Provisional application No. 61/008,267, filed on Dec. 19, 2007.

(51) Int. Cl. C10L 1/18; B01J 19/08

(52) U.S. Cl. 44/308; 422/186

(57) ABSTRACT

Methods of and systems for generating a bio-fuel from a bio-substance with the assistance of radio frequency heating are taught. In some embodiments, the system includes a reactant containing a bio-substance and an alcohol, a catalyst to be mixed with the reactant, and a radio frequency wave generator for generating a radio frequency wave to be applied to the bio-substance. The bio-substance comes from any appropriate sources including animal oils and fats, such as beef tallow. Alternatively, the bio-substance is able to come from a plant, a fungus, or a protist. One example would be canola oil. In some embodiments, the catalyst is a transesterification catalyst, a Lewis acid, or a Lewis base such as sodium hydroxide. In some embodiments, the alcohol is methanol. In some embodiments, the bio-fuel is bio-diesel.

### CROSS-REFERENCE TO RELATED APPLICATIONS

This application claims priority from U.S. Provisional Patent Application Ser. No. 61/008,267, filed Dec. 19, 2007 and entitled DEVICE AND METHOD FOR THE PRODUCTION OF BIODIESEL FROM FATS AND OILS; which is hereby incorporated herein by reference in its entirety for all purposes.

### FIELD OF THE INVENTION

The present invention relates to the field of fuel production. More specifically, the present invention relates to the field of biological fuel production.

### BACKGROUND OF THE INVENTION

Biodiesel is an attractive alternative fuel commonly produced from vegetable oil/animal fat and methanol through transesterification (FIG. 1). It is renewable and biodegradable. Although its NOₓ emission is slightly higher than petroleum-based diesel, it emits less carbon monoxide, hydrocarbon, and particulate matters during burning. Biodiesel is considered to contribute much less greenhouse gas than fossil fuels, because the carbon in its feedstock originated mostly from carbon dioxide in the air. With biodiesel standards having been established (ASTM D6751 in USA; EN 14112 in Europe), biodiesel has been successfully commercialized in USA and Europe. As of January 2008, there have been over 170 commercial biodiesel production plants in the USA. Furthermore, since domestic feedstock is used, biodiesel plays an important role to relieve the dependence on foreign oil and strengthen the national energy security.

The most common feedstock for biodiesel production in USA is soybean oil, but because of its use as an edible vegetable oil, it is relatively expensive. Moreover, if a large amount of soybean oil is used for biodiesel production, a possible result is an edible oil shortfall, which may cause serious problems in developing countries.

Beef tallow is an alternative feedstock for biodiesel production. It is a cheap by-product of the meat industry with a large annual output, and only a small part of it is used in nonfood applications. Beef tallow has been successfully converted into biodiesel (beef tallow methyl ester, BTME) with alkaline catalysts. It is reported that beef tallow-based biodiesel has lower NOₓ emissions than soybean oil-based biodiesel and has better oxidative stability, although its cold flow properties are poorer.

Canola oil is another alternative feedstock for biodiesel production, because of its relatively high yield of oil per acre and potential for use in industrial production.

To improve the production efficiency, microwave heating has been employed in biodiesel production and shows a great accelerative effect. It took only several minutes to achieve a 95% conversion with microwave heating instead of more than one hour with conventional heating, although relatively large amounts of catalyst (5% KOH) were used in these studies.

### SUMMARY OF THE INVENTION

A method of and system for generating a bio-fuel from a bio-substance with the assistance of a radio frequency heating is taught herein.

In one aspect, the system for producing bio-fuel includes a reactant containing a bio-substance and an alcohol, a catalyst to be mixed with the reactant, and a radio frequency wave generator for generating a radio frequency wave to be applied to the bio-substance.

In some embodiments, the bio-substance comes from an animal. Alternatively, the bio-substance comes from one or more of a plant, a fungus, or a protist. In other embodiments, the bio-substance is canola oil. In some embodiments, the bio-substance includes an animal fat. In still some embodiments, the animal fat includes beef tallow.

In some embodiments, the catalyst includes a Lewis base. Alternatively, the catalyst includes sodium hydroxide. Alternatively, the catalyst includes a Lewis acid. In some embodiments, the catalyst includes a transesterification catalyst. In some embodiments, the alcohol is methanol.

In some embodiments, the molar ratio of the alcohol to the bio-substance is higher than or equal to 5:1. Alternatively, the molar ratio of the alcohol to the bio-substance is between 5:1 and 10:1. In other embodiments, the concentration of the transesterification catalyst to the bio-substance is between 0.2% to 0.8% based on the weight of the bio-substance.

In some embodiments, the radio frequency wave includes a radio frequency heating wave. In other embodiments, a conversion rate of the bio-substance is at least 65%. Alternatively, a conversion rate of the bio-substance is higher than or equal to 90%. In some embodiments, the radio frequency wave is applied for at least 1 minute.

In some embodiments, the bio-fuel includes a bio-diesel. In some embodiments, the bio-diesel has a viscosity lower than 5.3 mm²/s. Alternatively, the bio-fuel includes an alkyl ester. In some embodiments, the bio-substance is heated before exposing to the radio frequency wave.

In another aspect, the method of generating a bio-fuel includes mixing a bio-substance with an alcohol and an ion source and applying a radio frequency wave to the bio-substance.

In some embodiments, the bio-substance includes one or more of an animal fat, an animal oil, an animal tissue, or a plant oil. In some embodiments, the plant oil includes canola oil. Alternatively, the animal fat includes beef tallow. In some embodiments, the alcohol is methanol.

In some embodiments, the ion source comprises a proton or a hydroxide. In some embodiments, the ion source is sodium hydroxide, potassium hydroxide, lithium hydroxide, mono-protic acid, diprotic acid, or triprotic acid.

In some embodiments, the radio frequency wave includes radio frequency heating. In some embodiments, a step of heating before applying the radio frequency wave is performed. In some embodiments, the bio-fuel comprises a bio-diesel.

In yet another aspect, a method of generating a bio-fuel includes reacting a bio-substance with an alcohol through a transesterification reaction and assisting the transesterification reaction by applying a heating method, wherein the heating method is performed by changing a phase of an electromagnetic field, further wherein the electromagnetic field includes a wave with a wavelength longer than a microwave frequency wave.

In some embodiments, the heating method comprises radio frequency heating. In some embodiments, the bio-substance comprises a plant oil or an animal fat or oil.

In a further aspect, a method of generating a bio-fuel includes providing a bio-molecule and performing catalytic transesterification of the bio-molecule with the assistance of a polarized force having a frequency lower than the frequency of a microwave.

In some embodiments, the polarized force includes a force generated by a radio frequency energy. In some embodiments, the catalytic transesterification includes an alcohol and a transesterification catalyst, further wherein the transesterification catalyst comprises a base or a acid.

In another aspect, the method of providing a bio-fuel to an engine includes providing a bio-substance, a catalyst, and an alcohol to a bio-fuel reactor, exposing the bio-substance to a radio frequency wave for a predetermined amount of time to generate the bio-fuel, and providing the bio-fuel to the engine.

In some embodiments, the bio-substance is an animal fat or an animal oil. In some embodiments, the bio-substance is a plant or a plant seed oil.

### BRIEF DESCRIPTION OF THE DRAWINGS

FIG. 1 shows a general scheme of biodiesel generation.

FIG. 2 shows an apparatus for bio-diesel production in accordance with the present invention.

FIG. 3 shows a ¹H NMR spectra of canola oil, biodiesel, and a typical reaction product. (RF heating 2 minutes; NaOH concentration 0.6%; molar ratio of methanol to oil 7:1; conversion rate 86.8%)

FIG. 4 shows a ¹H NMR spectra of reaction product. (RF heating 3 minutes; NaOH concentration 0.4%; molar ratio of methanol to oil 7:1; conversion rate 81.4%).

FIG. 5 shows response surface plots based on eq 3: (A) RF heating time 2 minutes; (B) RF heating time 3 minutes.

FIG. 6 shows temperature ramp of the reactants during RF irradiation vs NaOH concentration (A) based on methanol volume (w_{NaOH}/Vₘₑₜₕₐₙₒₗ) and (B) based on whole reactant volume (w_{NaOH}/(Vₘₑₜₕₐₙₒₗ+Vₒᵢₗ)).

FIG. 7 shows response surface plots of the biodiesel conversion rate at the central point of the CCD: (A) fixing RF heating time at 3 minutes; (B) fixing NaOH concentration at 0.4%; (C) fixing methanol/tallow ratio at 7:1.

FIG. 8 shows response surface plots of the biodiesel conversion rate with fixed RF heating time of 5 minutes.

FIG. 9 shows an application of the biodiesel converter in accordance with the present invention.

FIG. 10 shows the principle of RF wave heating.

FIG. 11 shows a flow chart illustrating the method of generating a bio-fuel from a bio-substance and the use of the bio-fuel generated.

### DETAILED DESCRIPTION OF THE PREFERRED EMBODIMENT

To achieve a higher production efficiency, radio frequency (RF heating) is employed as an alternative method to microwave heating in bio-diesel production. RF heating, a dielectric heating technology, has a similar heating mechanism to microwave heating. However, compared to microwave heating, a RF heating system are simpler to configure, have higher electricity to electromagnetic power conversion efficiency, and a deeper penetration of RF energy into a wide array of materials. Thus, a RF heating system is more economically feasible than microwave heating, and a RF heating system is more suitable to be applied in large commercial scale reactors. Therefore, it is desirable to have systems and methods using RF heating to assist a biodiesel conversion from plant oils and animal fats.

Methods of and systems for generating a bio-fuel from a bio-substance with the assistance of a radio frequency heating are taught herein. In some embodiments, the system includes a reactant containing a bio-substance and an alcohol, a catalyst to be mixed with the reactant, and a radio frequency wave generator for generating a radio frequency wave to be applied to the bio-substance. The bio-substance comes from any appropriate sources including animal oils and fats, such as beef tallow. Alternatively, the bio-substance is able to come from a plant, a fungus, or a protist. One example would be canola oil. In some embodiments, the catalyst is a transesterification catalyst, a Lewis acid, or a Lewis base such as sodium hydroxide. In some embodiments, the alcohol is methanol. In some embodiments, the bio-fuel is bio-diesel.

A person skilled in the art will appreciate that the technology disclosed herein is able to be applied to various fields and be used along or in combination with other technology. The application includes, but is not limited to internal combustion engines, industrial and home use scale bio-fuel production, bio-technology applications, cosmetic product applications, therapeutic treatment applications, and food preservative and processing applications.

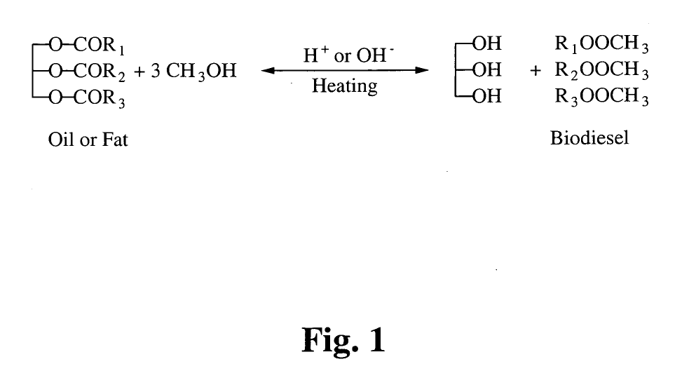

FIG. 1 shows a general scheme of biodiesel generation.

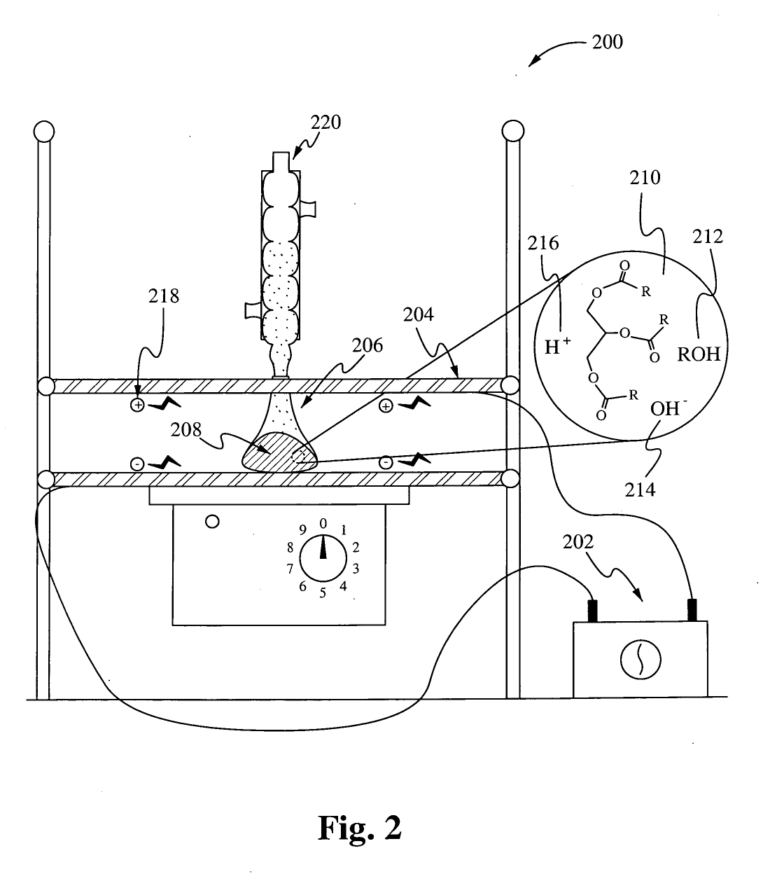

FIG. 2 shows an apparatus for bio-diesel production according to some embodiments. The system 200 includes a flask 206 having a reactant 208 containing a bio-substance 210 and an alcohol 212. The reactant 208 is mixed with a base 214 or an acid 216. A radio frequency (RF) wave 218 generated from a radio frequency source 202 is applied to the reactant.

Canola oil and beef tallow experiments have been performed as examples of the embodiments herein described.

### Chemicals

Canola Oil Experiments

Methanol and sodium hydroxide, both purchased from Fisher Scientific, are of analytic grade. Canola oil is purchased from a local grocery store. An average value of 879 is taken as the molecular weight of the oil. Chloroform-d (99.8%, contained 0.03% TMS) is purchased from Aldrich for nuclear magnetic resonance (NMR) analysis. All reagents were used as received.

Beef Tallow Experiments

Beef tallow is provided by the Lambert-Powell Meat Laboratory at Auburn University. An average value of 864 is taken as the molecular weight of the fat. Methanol, acetic acid, and sodium hydroxide are of analytic grade and are purchased from Fisher Scientific. Chloroform-d (99.8%, contained 0.03% TMS) is purchased from Aldrich for nuclear magnetic resonance (NMR) analysis. All reagents are used as received.

### Experimental Design

Canola Oil Experiments

Response surface modeling, RSM, a mathematical and statistical technique for designing experiments, building models, and evaluating effects of independent variables, is employed. Three factors, RF heating time, catalyst dose, and molar ratio of methanol to oil, are selected as the independent variables, and a central composite design (CCD) with five levels is performed (Table 1). The central values, step sizes, and ranges chosen are the following: RF heating time 2 minutes, step 0.5 minute, 1-3 minutes range; NaOH concentration (w/w, based on oil) 0.6%, step 0.2%, 0.2-1.0% range; and methanol/oil molar ratio 7:1, step 1:1, with range 5:1-9:1.

TABLE 1
Central composite design matrix and experimental results for canola oil

| | | | | | | | Temperature | | | |
|---|---|---|---|---|---|---|---|---|---|---|
| | Natural value^{a} | | | Code value | | | ramp | final | Conversion rate^{b} (%) | |
| Run | X₁ | X₂ | X₃ | x₁ | x₂ | x₃ | (° C./min) | (° C.) | Observed | Predicted |
| 1 | 1.5 | 0.8 | 6 | −1 | 1 | −1 | 3.7 | 26.1 | 86.4 | 88.1 |
| 2 | 2.5 | 0.4 | 8 | 1 | −1 | 1 | 12.4 | 50.9 | 83.6 | 81.4 |
| 3 | 2.0 | 0.6 | 7 | 0 | 0 | 0 | 12.2 | 44.0 | 86.8 | 86.4 |
| 4 | 1.5 | 0.8 | 8 | −1 | 1 | 1 | 12.2 | 38.3 | 91.1 | 90.9 |
| 5 | 1.5 | 0.4 | 8 | −1 | −1 | 1 | 13.7 | 41.1 | 79.3 | 78.4 |
| 6 | 2.0 | 0.6 | 7 | 0 | 0 | 0 | 11.8 | 43.3 | 86.1 | 86.4 |
| 7 | 1.5 | 0.4 | 6 | −1 | −1 | −1 | 8.9 | 33.3 | 75.8 | 75.6 |
| 8 | 2.5 | 0.8 | 6 | 1 | 1 | −1 | 3.6 | 28.8 | 89.3 | 91.2 |
| 9 | 2.0 | 0.6 | 7 | 0 | 0 | 0 | 13.5 | 46.9 | 86.0 | 86.4 |
| 10 | 2.5 | 0.8 | 8 | 1 | 1 | 1 | 10.7 | 46.3 | 92.2 | 93.9 |
| 11 | 2.5 | 0.4 | 6 | 1 | −1 | −1 | 9.2 | 43.3 | 80.2 | 78.6 |
| 12 | 2.0 | 0.6 | 7 | 0 | 0 | 0 | 12.6 | 44.9 | 87.0 | 86.4 |
| 13 | 3.0 | 0.6 | 7 | 2 | 0 | 0 | 8.3 | 45.9 | 89.2 | 89.4 |
| 14 | 2.0 | 0.6 | 9 | 0 | 0 | 2 | 12.6 | 45.3 | 88.1 | 89.2 |
| 15 | 2.0 | 0.6 | 7 | 0 | 0 | 0 | 9.5 | 39.4 | 87.0 | 86.4 |
| 16 | 2.0 | 0.6 | 7 | 0 | 0 | 0 | 9.3 | 38.8 | 86.3 | 86.4 |
| 17 | 2.0 | 0.2 | 7 | 0 | −2 | 0 | 14.4 | 49.7 | 64.9 | 67.3 |
| 18 | 2.0 | 0.6 | 5 | 0 | 0 | −2 | 3.5 | 27.1 | 84.4 | 83.6 |
| 19 | 2.0 | 1.0 | 7 | 0 | 2 | 0 | 6.3 | 33.3 | 94.9 | 92.4 |
| 20 | 1.0 | 0.6 | 7 | −2 | 0 | 0 | 9.5 | 29.8 | 83.3 | 83.4 |

^{a}X₁ = RF heating time (min), X₂ = NaOH concentration (%, w/w, based on oil), X₃ = molar ratio of methanol to canola oil.
^{b}Conversion rate was calculated by: (1 − (remaining canola oil after reaction/total canola oil before reaction)) × 100%.

Beef Tallow Experiments

Response surface methodology is employed. The three most important factors for biodiesel conversion, 1) RF heating time, 2) catalyst dose and 3) methanol/tallow molar ratio, are selected as the independent variables, and a central composite design (CCD) with five levels is performed (Table 2). One 20-g batch of beef tallow is used for each variable combination. After a set of preliminary experiments, the central values, step sizes, and ranges of the variables are chosen as follows: RF heating time 3 minutes, step 1 minutes, 1-5 minutes range; NaOH concentration (w/w, based on tallow) 0.4%, step 0.1%, 0.2-0.6% range; and methanol/tallow molar ratio 7:1, step 1:1, and a 5:1-9:1 range.

TABLE 2
Central composite design matrix and
experimental results for beef tallow

| | Natural value^{a} | | | Code value | | | Conversion rate (%) | |
|---|---|---|---|---|---|---|---|---|
| Run | X₁ | X₂ | X₃ | x₁ | x₂ | x₃ | Observed^{b} | Predicted |
| 1 | 2 | 0.5 | 6 | −1 | 1 | −1 | 81.8 | 80.2 |
| 2 | 4 | 0.3 | 8 | 1 | −1 | 1 | 75.2 | 77.1 |
| 3 | 3 | 0.4 | 7 | 0 | 0 | 0 | 81.2 | 80.3 |
| 4 | 2 | 0.5 | 8 | −1 | 1 | 1 | 81.8 | 83.7 |
| 5 | 2 | 0.3 | 8 | −1 | −1 | 1 | 69.3 | 70.3 |
| 6 | 3 | 0.4 | 7 | 0 | 0 | 0 | 80.1 | 80.3 |
| 7 | 2 | 0.3 | 6 | −1 | −1 | −1 | 69.5 | 66.8 |
| 8 | 4 | 0.5 | 6 | 1 | 1 | −1 | 85.7 | 87.1 |
| 9 | 3 | 0.4 | 7 | 0 | 0 | 0 | 82.0 | 80.3 |
| 10 | 4 | 0.5 | 8 | 1 | 1 | 1 | 90.2 | 90.6 |
| 11 | 4 | 0.3 | 6 | 1 | −1 | −1 | 75.3 | 73.7 |
| 12 | 3 | 0.4 | 7 | 0 | 0 | 0 | 83.2 | 80.3 |
| 13 | 5 | 0.4 | 7 | 2 | 0 | 0 | 85.1 | 87.2 |
| 14 | 3 | 0.4 | 9 | 0 | 0 | 2 | 86.0 | 83.8 |
| 15 | 3 | 0.4 | 7 | 0 | 0 | 0 | 81.4 | 80.3 |
| 16 | 3 | 0.4 | 7 | 0 | 0 | 0 | 80.5 | 80.3 |
| 17 | 3 | 0.2 | 7 | 0 | −2 | 0 | 59.7 | 60.5 |
| 18 | 3 | 0.4 | 5 | 0 | 0 | −2 | 74.2 | 76.8 |
| 19 | 3 | 0.6 | 7 | 0 | 2 | 0 | 88.3 | 87.4 |
| 20 | 1 | 0.4 | 7 | −2 | 0 | 0 | 69.5 | 73.4 |

^{a}X₁ = RF heating time (min), X₂ = NaOH concentration (%, w/w, based on tallow), X₃ = molar ratio of methanol to tallow.
^{b}Conversion rate was calculated by: (1 − (remaining tallow after reaction/total tallow before reaction)) × 100%.

For Both Canola Oil and Beef Tallow Experiments

For developing the regression equation, the variables are coded according to Eq. (1):

$${x}_{i} = \frac{{X}_{i} - {X}_{i}^{*}}{Δ {X}_{i}} \qquad ( 1 )$$

where xᵢ is the coded value of the ith variable, Xᵢ is the natural value of the ith variable, Xᵢ* is the central value of Xᵢ in the investigated area, and ΔXᵢ is the step size.

The experimental results are fitted using a polynomial quadratic equation in order to correlate the response variable to the independent variables. The general form of the polynomial quadratic equation is:

$$Y = {A}_{0} + {\sum }_{i = 1}^{k} {B}_{i} {x}_{i} + {\sum }_{i = 1}^{k} {C}_{ii} {x}_{i}^{2} + {\sum }_{i = 1}^{k} {\sum }_{j = 1}^{k} {D}_{ij} {x}_{i} {x}_{j} \qquad ( 2 )$$

where xᵢ are the input variables, which influence the response variable Y, and A₀, Bᵢ, Cᵢᵢ, and Dᵢⱼ are the regression coefficients. Origin 7.0 (OriginLab Corp., USA) is used for the regression analysis.

### Biodiesel Production

Canola Oil Experiments

FIG. 2 shows an apparatus for bio-diesel production according to some embodiments. An RF heating apparatus 202 (SO6B; Strayfield Fastran, UK) is employed. The distance between the two electrodes 204 is at 15 cm. A 150-mL conical flask 206 with reflux condenser 220 is used as a reactor. Sodium hydroxide is dissolved in methanol before addition of canola oil. For each RSM experiment, 20 g of canola oil is used. The reactants are mixed with a magnetic stir bar in the vessel. The stirring starts 2 minutes before the RF heating and lasts another 5 minutes after the RF heating to allow sufficient time for the heat absorbed during RF irradiation to be used in the transesterification reaction. The transesterification reaction time is the RF heating time plus 5 minutes. All experiments are initiated with canola oil temperatures at ambient conditions (ca. 20° C.). The temperature of the reactants is monitored using a fiber-optic sensor (ReFlex, Neoptix Inc., USA). After cessation of stirring, the reactants would separate into two distinct layers—an upper layer containing biodiesel and unreacted oil plus a lower layer containing glycerin.

Beef Tallow Experiments

FIG. 2 also shows another embodiment. An RF heating device (SO6B; Strayfield Fastran, UK) is employed, and the distance between the two electrodes 204 is at 15 cm. Beef tallow is placed into a conical flask 206 and heats to 55° C. in an oven. Then, certain amounts of methanol and sodium hydroxide (pre-dissolved in methanol) are added. The reactants are immediately mixed with a magnetic stir bar. After 1 minutes of stirring, RF heating is turned on for a predetermined time. Then, the stirring continues for an additional 5 minutes to allow the reactants to sufficiently utilize the energy absorbed during RF heating. All experiments can be performed under ambient temperatures (ca. 20° C.). The products would separate into two phases: an upper biodiesel/fat/methanol layer and a lower glycerin/methanol layer. Products for viscosity analysis are further purified. The product is neutralized with acetic acid and poured into a separatory funnel. After removal of the lower glycerin/methanol layer, the product is washed with warm water several times. Then, the organic layer is heated in a rotary evaporator under vacuum at 80° C. to constant weight to remove the remaining water and methanol.

Above mentioned chemicals, reaction conditions, equipments, and the orders of adding materials for both reactions are described as examples, and it should be understood that there are alternative choices. The inventors have no intention to limit the scope to the above described chemicals and reaction conditions. The reactants, reaction conditions, solvents, and energy sources are substitutable with other chemicals, conditions, solvents, and energy sources whether or not listed above. The results of some more exemplary experiments are shown in Tables 1 and 2.

### Product Analysis

Canola Oil Experiments

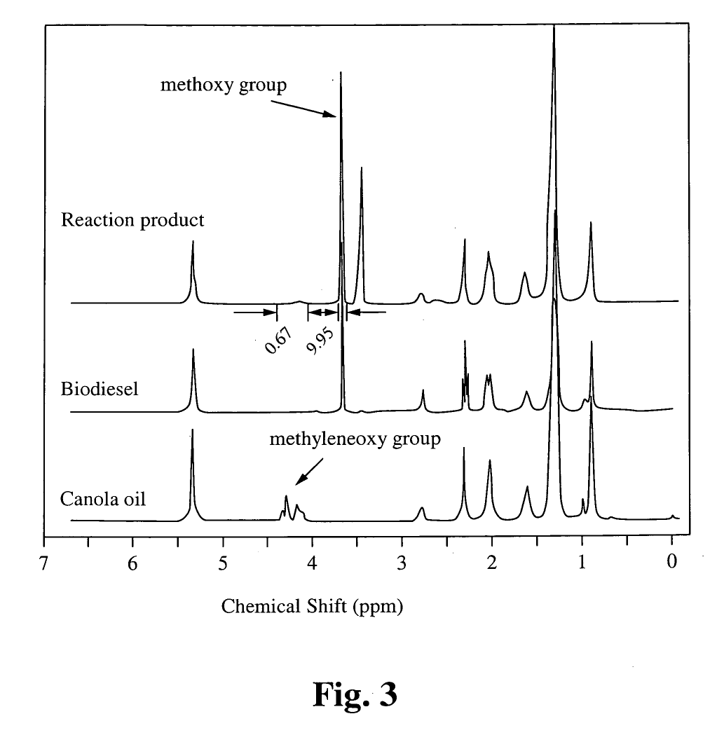

FIG. 3 shows the results of the canola oil to biodiesel conversion. In one embodiment, a 250 MHz NMR spectrometer (AVANCE II 250, Bruker, Germany) is used to record the ¹H NMR spectra of the reaction products. A 0.2 mL aliquot of the upper layer (mixture of biodiesel and remaining oil) of the products is dissolved in 0.4 mL of chloroform-d for the analysis. Generally, gas chromatography (GC), as specified in the ASTM D6751 standard for biodiesel fuels (D6584 is the procedure itself) or high-performance liquid chromatography (HPLC) are employed for determining the completeness of the transesterification reaction. Using chromatographic equipment, amounts of remaining reactants (oil and methanol), intermediates (diglycerides and monoglycerides), and products (biodiesel and glycerol) are able to be comprehensively determined. This analysis, however, is time-consuming and expensive. For the purposes of this study, a fast and simple method of determining conversion efficiency was most important. NMR analysis fulfilled these requirements and has been shown to be accurate as well. The ¹H NMR spectra of canola oil, biodiesel, and a typical reaction product from this study with a conversion rate of 86.8% are illustrated in FIG. 3. Two distorted double-doublets, assigned to the H atoms of the methyleneoxy groups in oil (triacylglycerol esters), appeared between 4.1 to 4.4 ppm on the spectrum of canola oil. A high singlet at 3.66 ppm is evident on the biodiesel spectrum. This peak is assigned to the H atoms of the methoxy group in biodiesel (fatty acid methyl esters). The transesterification reaction converting oil to biodiesel is evident as the reduction in the NMR spectrum in the 4.1-4.4 ppm range and the increase in the 3.66 ppm range. The ratio of the areas under those spectral curve segments is a measure of the reaction completeness.

Beef Tallow Experiments

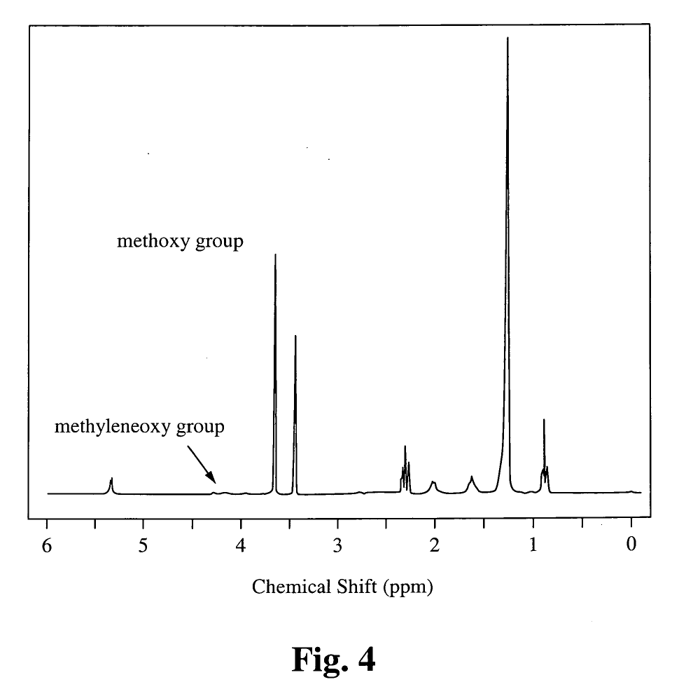

FIG. 4 shows results of the beef tallow to biodiesel conversion. In some embodiments, a 250 MHz NMR spectrometer (AVANCE II 250, Bruker, Germany) is used to record ¹H NMR spectra of the products. A 0.2-mL aliquot of the upper layer (biodiesel and remaining tallow) of the products is dissolved in 0.4 mL chloroform-d for this analysis. FIG. 4 shows that the area ratio of the two distorted double doublets at 4.1-4.4 ppm (assigned to the methyleneoxy groups in fat) to the singlet at 3.66 ppm (assigned to the methoxy group in biodiesel) is used to calculate the conversion rate of the reaction. Kinematic viscosities of the reaction products are measured with a Cannon-Fenske routine viscometer (Cannon Instrument Co., PA, USA) at 40° C. according to the stand test method ASTM D445.

### Experimental Results

Canola Oil Experiments

Effects on Conversion Rate of RF Heating Time, NaOH Dose, and Methanol/Oil Molar Ratio

Table 1 is a summary of the independent variable combinations tested in this study for their influence on conversion rate of raw oil to biodiesel.

One 20 g batch of biodiesel is made for each combination and conversion efficiency evaluated using the NMR procedure outlined above. The resulting conversion rate is modeled using a second-order, multifactor regression equation. The full model, including interaction terms, is significant (P<0.05), but some parameters are not. Parameters are sequentially removed based on the coefficient's p-value (largest first) until all remaining parameters were significant (P<0.05). This resulted in the equation:

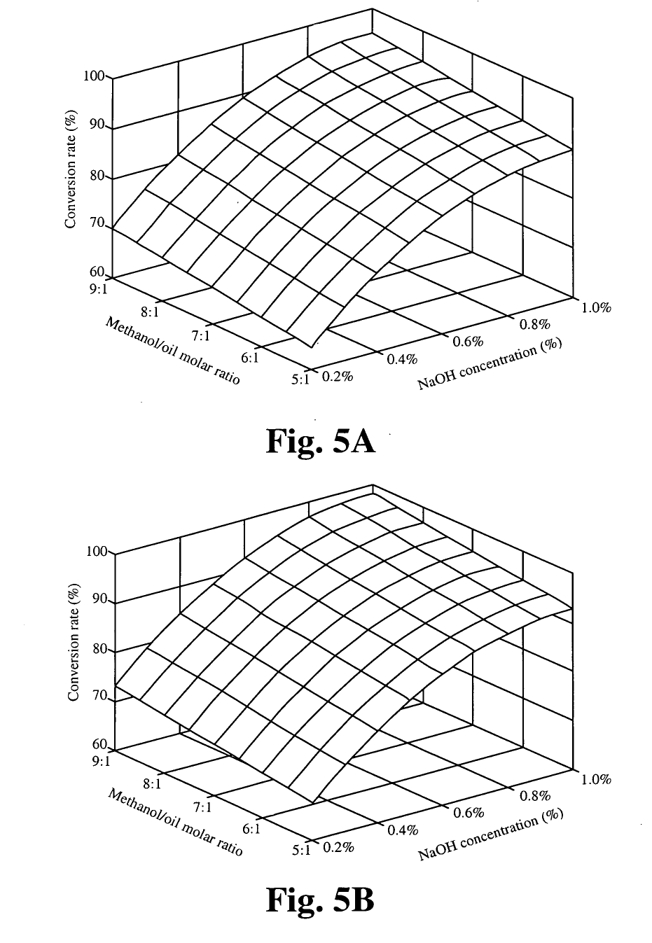

Y=86.402+1.521x₁+6.266x₂+1.382x₃−1.633x₂² (3)

where Y represents the conversion rate and x₁, x₂, and x₃ are the code values of RF heating time, NaOH concentration, and methanol/oil molar ratio, respectively. The regression details are listed in Tables 3 and 4. The high coefficient of determination (R²=0.947) and F-value (87.18) suggested that this model was an accurate representation of the experimental data. The small p-values (<0.05) in Table 4 confirms that heating time, NaOH dose, and methanol/oil molar ratio all significantly influenced the transesterification reaction. There are no significant interaction effects between any of the tested variables. FIG. 5 illustrates the response surfaces of equation 3 with a heating time of 2 minutes (A) and 3 minutes (B). The conversion rate increases with the increasing of RF heating time, NaOH concentration, and methanol/oil molar ratio. Concentration of NaOH shows the largest positive impact on conversion efficiency, especially in the low NaOH dose range. The effect tends to diminish, however, as concentrations approached 1.0%. The highest conversion rate of 98.2% is predicted, based on the model, to occur with parameter values of RF heating time of 3 minutes; NaOH concentration 1.0%; and methanol/oil molar ratio 9:1. To test the validity of the conversion efficiency, three additional batches are performed under the conditions producing the highest predicted conversion rate. An average conversion rate of 97.7%±0.4% is observed, which is close to the model-predicted value of 98.2%, indicating that, for the parameter values tested, RSM analysis is a useful technique to estimate the influence of important factors on biodiesel production.

TABLE 3
ANOVA analysis for Eq. (3)

| | Degrees of | Sum of | | | |
|---|---|---|---|---|---|
| | freedom | square | Mean square | F-value | p-value |
| Model | 4 | 768.214 | 192.054 | 87.187 | <0.0001 |
| Error | 15 | 33.042 | 2.203 | | |
| Total | 19 | 801.256 | | | |

R² = 0.947

TABLE 4
Estimated regression coefficients for Eq. (3)

| Coefficient | Value | Error | t-value | p-value |
|---|---|---|---|---|
| A₀ | 80.402 | 0.403 | 214.688 | <0.0001 |
| B₁ | 1.521 | 0.371 | 4.098 | 0.0009 |
| B₂ | 6.266 | 0.371 | 16.887 | <0.0001 |
| B₃ | 1.382 | 0.371 | 3.724 | 0.0020 |
| C₂₂ | −1.633 | 0.285 | −5.738 | <0.0001 |

RF Heating Efficiency

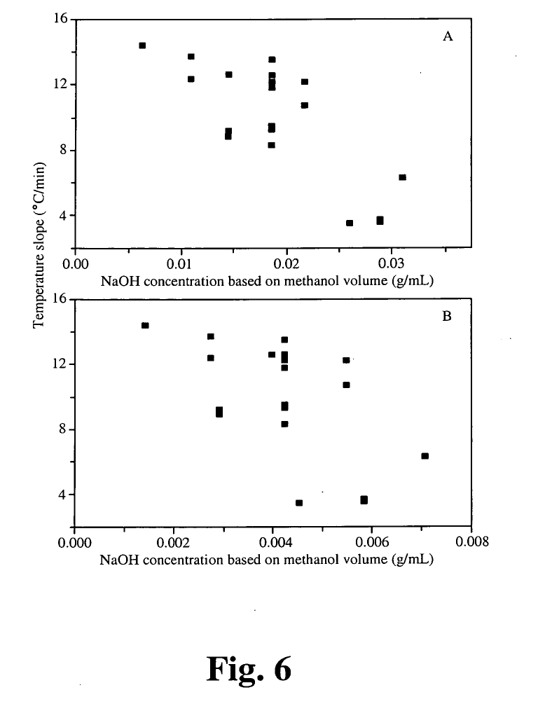

The heating efficiency of the RF system is indicated by the rate at which temperature of the reactants rose during irradiation. FIG. 6 shows the relationship between temperature rise and NaOH concentrations calculated in two different ways. It is evident that temperature increase is more closely correlated with NaOH concentration based on methanol volume than that based on the volume of all reactants. RF heating is accomplished through a combination of dipole rotation of polar molecules and electric resistance heating resulting from movements of dissolved ions. Under the conditions found in the transesterification reaction, ionic conductivity plays the major role in RF heating. Since NaOH does not dissolve in oil, the conductivities of Na⁺ and OH⁻ in the reactants are mainly determined by the amounts of NaOH and methanol. In the investigated range, the rate of increase in reactant temperature tends to drop with increasing NaOH concentration. High NaOH doses, therefore, would tend to reduce RF heating efficiency, although its catalytic ability would accelerate the transesterification. High sodium hydroxide doses, however, create increased difficulties in downstream processing. Therefore, by comprehensively considering the cost of energy, reagent, reaction time, and downstream processing, the results of this study suggest that relatively low NaOH dose (0.6-0.8%, based on oil) and high methanol/oil molar ratio (6:1-9:1) would be most economical for catalyzing transesterification assisted by RF heating, while still providing acceptable conversion efficiency. An average conversion rate of 97.7%±0.4% was observed at conditions of RF heating time of 3 minutes; NaOH concentration 1.0%; and methanol/oil molar ratio 9:1. The heating time of 3 minutes is much shorter than the conventional heating method (60 minutes). This phenomenon might be attributed to the following mechanisms. RF heating is achieved by direct interaction between an electromagnetic field and dipole molecules and ion pairs in biomaterials. Heat is generated as the electromagnetic field reverses the polarization of individual molecules or causes migration of ions as the field alternates at high frequency. Conventional heating requires energy be absorbed by the entire mass through conduction/convection, raising the energy level, or temperature, of the entire mass. In RF heating, however, only ions/dipole molecules absorb energy, and these are the components driving the transesterification reaction. These selectively heated components achieve an energy state that is great enough to complete the transesterification reaction, while the products of which subsequently absorb relatively little RF energy. The incident RF energy is then available to drive further reactions, rather than simply heat the entire mass of reactants. This is probably the key mechanism behind the greatly accelerated reaction rate observed when using electromagnetic heating, rather than the conventional approach.

### Increased Scale Experiment

A preliminarily investigation is made into the potential for industrial application of RF heating for biodiesel production. In this experiment, the scale of the reaction is increased five times, to the maximum capacity of the conical flask used in the study. Three 100 g batches of oil were subjected to transesterification at the central point of the CCD (RF heating time 2 minutes, NaOH concentration (based on oil) 0.6%, and methanol/oil molar ratio 7:1). A conversion rate of 86.6±0.9% was observed for the larger reaction batches, which matches well with the result of the previous small batch experiments (86.4±0.5%). This result is felt to be at least limited evidence to indicate the scale-up potential of RF heating for production of biodiesel.

### Beef Tallow Experiments

Effects of RF Heating Time, NaOH Dose, and Methanol/Tallow Molar Ratio on BTME Conversion

The tested variable combinations and experimental results are listed in Table 2. Response surface analysis is performed to evaluate the influence of the three independent variables, such as RF heating time, NaOH dose, and methanol/tallow molar ratio, on BTME conversion. The resulting conversion rates are regressed with Equation (2). Statistical analysis indicated that the whole regression model is significant (P<0.05), but some individual parameters are not. Insignificant parameters are sequentially removed based on the coefficients' p-values (largest first) until all remaining parameters are significant (P<0.05), resulting in the equation as follows:

Y=80.264+3.447x₁+6.727x₂+1.744x₃−1.589x₂² (4)

where Y represents the conversion rate, and x₁, x₂, and x₃ are the code values of RF heating time, NaOH concentration, and methanol/tallow molar ratio, respectively. The high coefficient of determination (R²=0.937) and F-value (55.477) in Table 5 suggests that this model is an accurate representation of the experimental data. The small p-values (<0.05) in Table 6 confirms that all three variables investigated in this work significantly influenced the transesterification reaction.

TABLE 5
ANOVA analysis for Eq. (4)

| | Degrees of | Sum of | | | |
|---|---|---|---|---|---|
| | freedom | square | Mean square | F-value | p-value |
| Model | 4 | 1031.463 | 257.866 | 55.477 | <0.0001 |
| Error | 15 | 69.728 | 4.649 | | |
| Total | 19 | 1101.191 | | | |

R² = 0.937

TABLE 6
Estimated regression coefficients for Eq. (4)

| Coefficient | Value | Error | t-value | p-value |
|---|---|---|---|---|
| A₀ | 80.264 | 0.585 | 137.288 | <0.0001 |
| B₁ | 3.447 | 0.539 | 6.395 | <0.0001 |
| B₂ | 6.727 | 0.539 | 12.480 | <0.0001 |
| B₃ | 1.744 | 0.539 | 3.236 | 0.0055 |
| C₂₂ | −1.589 | 0.413 | −3.843 | 0.0016 |

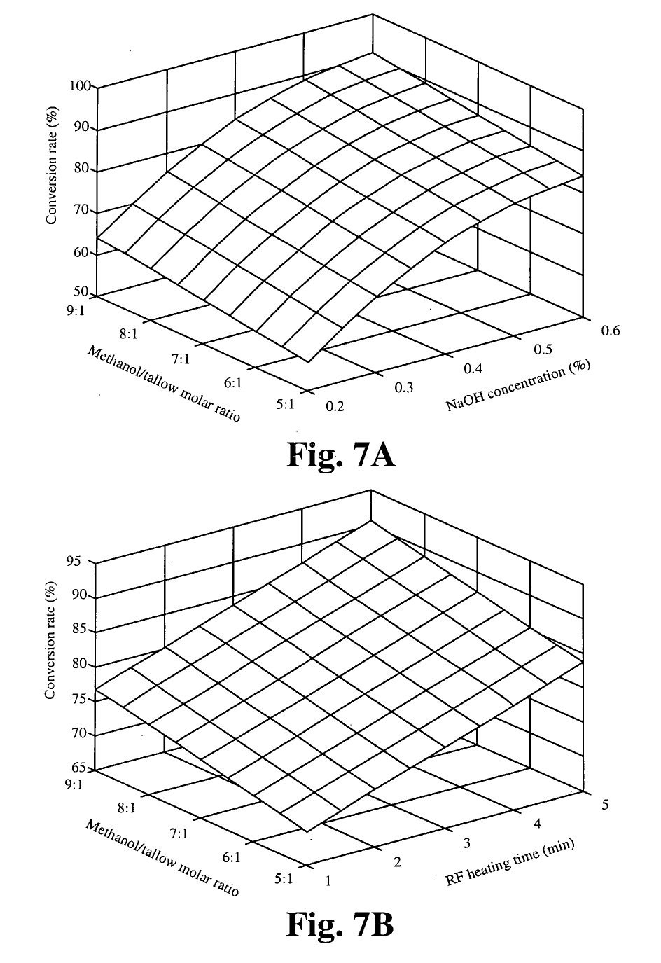

FIG. 7 shows a numerical analysis of the results. FIG. 7 illustrates the response surfaces based on Equation (4) with keeping one variable constant at the central point of the CCD and varying the other two within their experimental ranges. The conversion rate increases with the increasing of RF heating time, NaOH concentration, and methanol/tallow molar ratio, while NaOH concentration shows the largest impact. No evident interaction among the three investigated factors is observed.

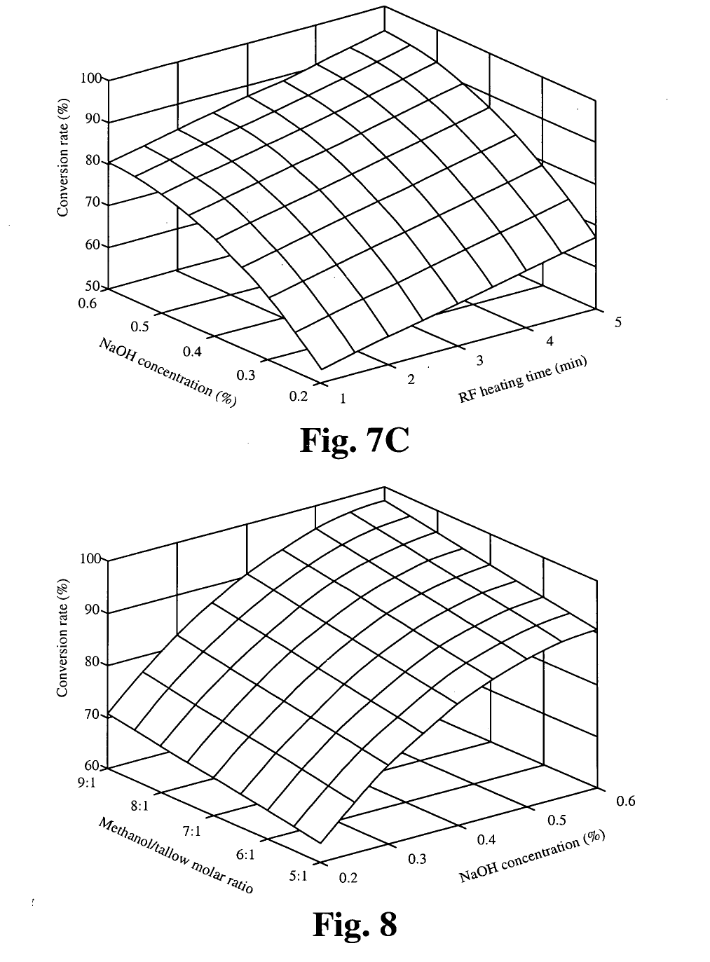

FIG. 8 shows another data analysis of the results. FIG. 8 illustrates the response surface with RF heating time of 5 minutes. The highest conversion rate based on the model, 97.7%, is observed at the point of NaOH concentration of 0.6%, RF heating time of 5 minutes, and methanol/tallow ratio of 9:1. To confirm the validity of the statistical experimental strategies, three additional experiments are performed under this condition. A slightly lower conversion rate, 96.3±0.5%, is obtained, indicating that the RSM successfully estimates the impacts of the variables investigated in this work.

Biodiesel Production from Beef Tallow and Canola Oil with RF Heating

RF heating is achieved as the electromagnetic field reverses the polarization of individual molecules or causes migration of ions as the field alternates at high frequency. Thus, it is difficult for the weak-polar tallow molecules in a solid state to absorb the energy from the RF electromagnetic field. So, the tallow is difficult to melt if the reaction starts under ambient temperatures, and the stirring bar cannot mix the reactants well. Therefore, different from the conversion of canola oil, a pre-heating procedure is necessary for beef tallow conversion. The tallow is heated to 55° C. before transesterification, which ensured the high efficiency of the RF heating reaction. It is suggested that, for industrial production, beef tallow rendering should be immediately followed by biodiesel conversion to obtain the best economic feasibility. To compare the reaction efficiencies of beef tallow and canola oil, three batches of canola oil are converted into biodiesel at the central point of the CCD (NaOH concentration: 0.4%, RF heating time: 3 minutes and methanol/oil ratio: 7:1) through the pre-heating procedure. A conversion rate of 84.4±0.4% is observed, which is slightly higher than the 81.4±1.1% for beef tallow.

Although there are some differences between the biodiesel production processes for beef tallow and canola oil with RF heating assistance, most aspects of the reactions are similar. High conversion rates are achieved from both feedstocks in 10 minutes with RF heating, which is much faster than using conventional heating. Moreover, an RSM model similar to Equation (4) obtained for biodiesel production from canola oil suggests that the impacts of NaOH dose, RF heating time, and ratio of methanol to tallow or oil on the conversion are also similar. Therefore, the fast biodiesel production method using RF heating should be applicable on a wide range of vegetable oils and animal fats represented by canola oil and beef tallow, respectively.

### Viscosity

A main obstacle which prevents vegetable oil and animal fat from being directly used in modern diesel engine is their high viscosity. The viscosity will remarkably decrease after the conversion from oil/fat into biodiesel. Canola oil is converted into biodiesel (canola oil methyl ester, COME) under the condition of NaOH concentration: 1.0%, RF heating time: 4 minutes and methanol/oil ratio: 9:1 for viscosity test. The BTME is produced under the condition of NaOH concentration: 0.6%, RF heating time: 7 minutes and methanol/tallow ratio: 9:1. The conversion rates of the COME and the BTME are both higher than 99%. The kinematic viscosity of the original canola oil is 39.9±0.2 mm²/s at 40° C., while the beef tallow is solid at the same temperature. After the conversion, the kinematic viscosities of COME and BTME are 4.86±0.01 and 5.23±0.01 mm²/s, respectively, which are similar to the previous reported values and both met the specification in ASTM D6751 (1.9-6.0 mm²/s). The viscosity of BTME is slightly higher than that of COME, which probably is attributed to beef tallow containing more saturated fatty esters than canola oil. The same reasoning could explain why BTME has poorer low-temperature properties than COME, but this is compensated with BTME's better oxidative stability.

### Application

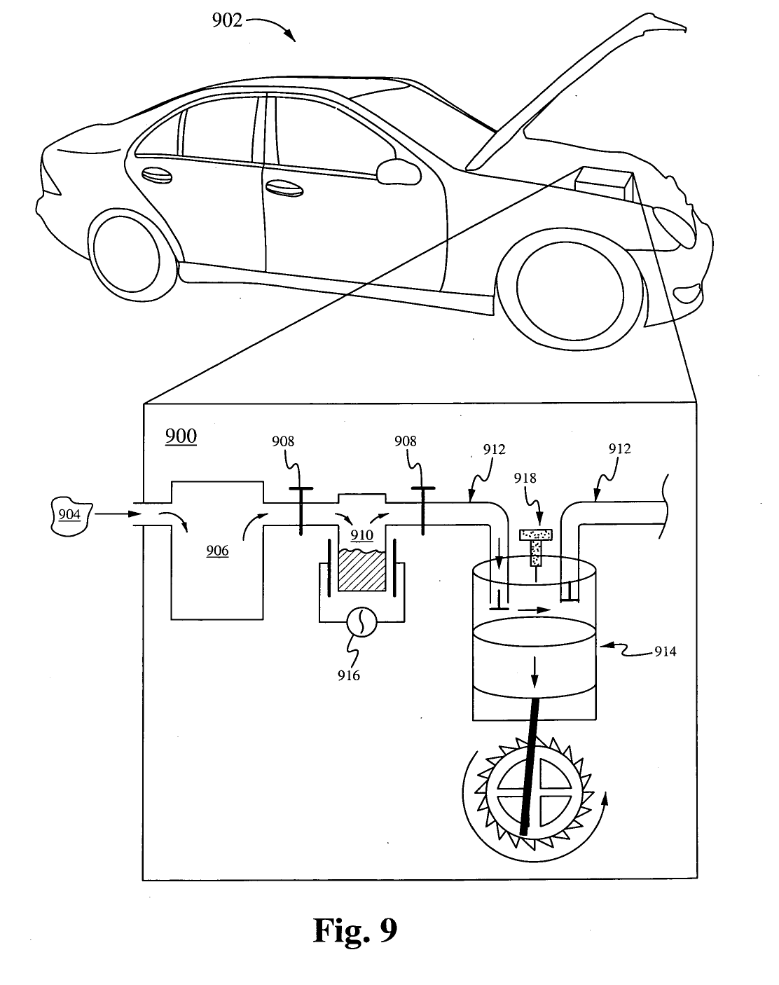

FIG. 9 shows an application of the biodiesel converter. The biodiesel converter 900 is able to be installed onboard a car 902. In one embodiment, the biodiesel converter 900 takes bio-substance from the bio-substance inlet 904, stores the bio-substance in the fuel tank 906, controls the input and output coupled to a biodiesel converting unit 910 by the valve 908, receives RF heating wave through the RF heat generator 916, and provides biodiesel fuel to an engine 914 through the pipes 912. The engine 914 can then be driven by the biodiesel fuel ignited by the spark plug 918.

### The Principle of RF Wave Heating

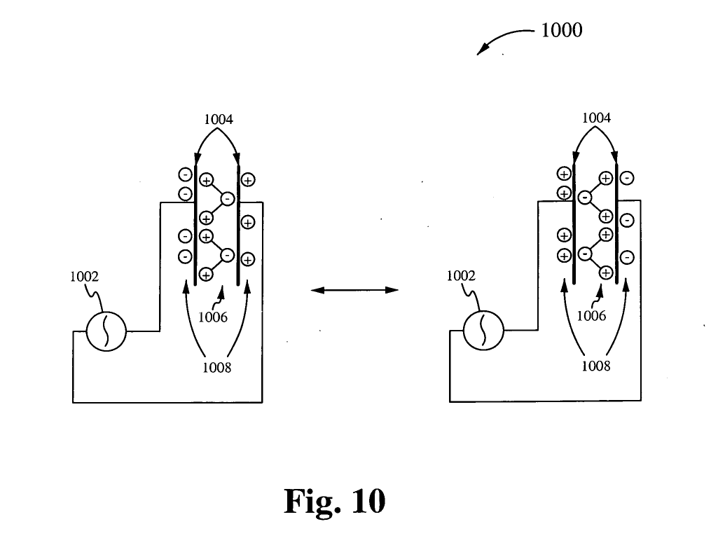

FIG. 10 shows the principle of RF wave heating. The RF heating device 1000 contains a RF source 1002. The RF source 1002 generates charges 1008. The RF source 1002 powers the electrodes 1004, which generates the RF waves to make the polarizable molecules 1006 move and flip between the electrodes 1004 when the phases of the energy change. The RF wave heating is used as an example. Other electromagnetic waves and waves with energy can also be used. The electromagnetic waves and waves with energy can have a frequency or wavelength either higher or lower than RF waves.

The Method of Generating Bio-Fuel from a Bio-Substance and the Use of the Bio-Fuel

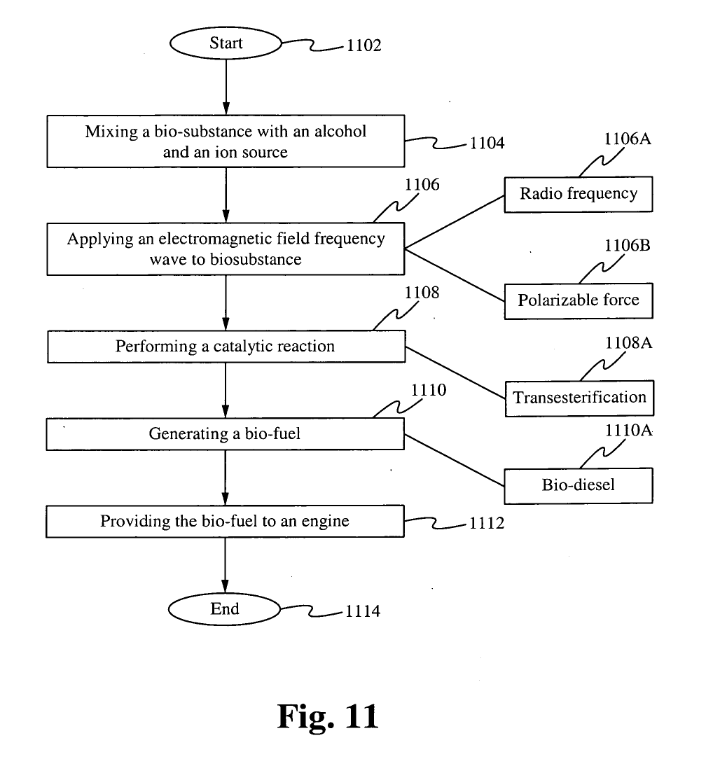

FIG. 11 shows a flow chart illustrating the method of generating a bio-fuel from a bio-substance and the use of the bio-fuel generated. The method of generating the bio-fuel begins at step 1102. At step 1104, a bio-substance or a bio-molecule is mixed with an alcohol and an ion source. In some embodiments, the ion source is optional. In some embodiments, the alcohol comes from an animal or a plant. At step 1106, an electromagnetic field frequency wave is applied to the bio-substance or bio-molecule. In some embodiments, the electromagnetic field is a radio frequency 1106A or a polarizable force 1106B. At step 1108, a catalytic reaction is performed with the assistance of an electromagnetic field frequency wave. In some embodiments, the catalytic reaction is catalytic transesterification. At step 1110, a bio-fuel is generated through the above steps. In some embodiments, the bio-fuel is a bio-diesel. At step 1112, the bio-fuel generated is provided to an engine or internal combustion engine. At step 1114, the process ends. The above steps are listed as examples of the processed described herein. The steps are able to be performed in any appropriate sequence. Additional steps are able to be added at any time, and the steps mentioned above are optional and are not all required. Chemicals and reaction conditions are all interchangeable throughout this disclosure and substitutable with the chemicals and reaction conditions that a person skilled in the art would appreciate.

Efficient biodiesel production from plant oils and animal fats is achieved through the assistance of radio frequency (RF) heating. In the example using beef tallow as the bio-substance, a conversion rate as high as 96.3% is obtained. In the example using canola oil as the bio-substance, a conversion rate as high as 97.3% is obtained. Scale-up experiments, from 20 g to 100 g, show that the conversion rate does not decrease due to the increase in the amount of the reactants. As described above, the high conversion rate and scale-up availability of the RF heating method indicating the potential industrial biodiesel production applications.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system for producing a bio-fuel comprising:
a. a reactant containing a bio-substance and an alcohol;
b. a catalyst to be mixed with the reactant; and
c. a radio frequency wave generator for generating a radio frequency wave to be applied to the bio-substance.

2. The system of claim 1, wherein the bio-substance comes from an animal.

3. The system of claim 1, wherein the bio-substance comes from one or more of a plant, a fungus, or a protist.

4. The system of claim 1, wherein the bio-substance comprises canola oil.

5. The system of claim 1, wherein the bio-substance comprises an animal fat.

6. The system of claim 5, wherein the animal fat comprises beef tallow.

7. The system of claim 1, wherein the catalyst comprises a Lewis base.

8. The system of claim 7, wherein the Lewis base comprises sodium hydroxide.

9. The system of claim 1, wherein the catalyst comprises a Lewis acid.

10. The system of claim 1, wherein the catalyst comprises a transesterification catalyst.

11. The system of claim 10, wherein the concentration of the transesterification catalyst to the bio-substance is between 0.2% to 0.8% based on the weight of the bio-substance.

12. The system of claim 1, wherein the alcohol comprises methanol.

13. The system of claim 1, wherein the molar ratio of the alcohol to the bio-substance is higher than or equal to 5:1.

14. The system of claim 1, wherein the molar ratio of the alcohol to the bio-substance is between 5:1 and 10:1.

15. The system of claim 1, wherein the radio frequency wave comprises a radio frequency heating wave.

16. The system of claim 1, wherein a conversion rate of the bio-substance is at least 65%.

17. The system of claim 1, wherein a conversion rate of the bio-substance is higher than or equal to 90%.

18. The system of claim 1, wherein the radio frequency wave is applied for at least 1 minute.

19. The system of claim 1, wherein the bio-fuel comprises a bio-diesel.

20. The system of claim 1, wherein the bio-diesel has a viscosity lower than 5.3 mm²/s.

21. The system of claim 1, wherein the bio-fuel comprises an alkyl ester.

22. The system of claim 1, wherein the bio-substance is heated before exposing to the radio frequency wave.

23. A method of generating a bio-fuel comprising:
a. mixing a bio-substance with an alcohol and an ion source; and
b. applying a radio frequency wave to the bio-substance.

24. The method of claim 23, wherein the bio-substance comprises one or more of an animal fat, an animal oil, an animal tissue, or a plant oil.

25. The method of claim 24, wherein the plant oil comprises canola oil.

26. The method of claim 24, wherein the animal fat comprises beef tallow.

27. The method of claim 23, wherein the alcohol is methanol.

28. The method of claim 23, wherein the ion source comprises a proton or a hydroxide.

29. The method of claim 23, wherein the ion source comprises sodium hydroxide, potassium hydroxide, lithium hydroxide, mono-protic acid, diprotic acid, or triprotic acid.

30. The method of claim 23, wherein the radio frequency wave comprises radio frequency heating.

31. The method of claim 23 further comprises a step of heating before applying the radio frequency wave.

32. The method of claim 23, wherein the bio-fuel comprises a bio-diesel.

33. A method of generating a bio-fuel comprising:
a. reacting a bio-substance with an alcohol through a transesterification reaction; and
b. assisting the transesterification reaction by applying a heating method, wherein the heating method is performed by changing a phase of an electromagnetic field, further wherein the electromagnetic field includes a wave with a wavelength longer than a microwave frequency wave.

34. The method of claim 33, wherein the heating method comprises radio frequency heating.

35. The method of claim 33, wherein the bio-substance comprises one or more of a plant oil or an animal fat or oil.

36. A method of generating bio-fuel comprising:
a. providing a bio-molecule; and
b. performing catalytic transesterification of the bio-molecule with the assistance of a polarized force having a frequency lower than the frequency of a microwave.

37. The method of claim 36, wherein the polarized force comprises a force generated by a radio frequency energy.

38. The method of claim 36, wherein the catalytic transesterification comprises an alcohol and a transesterification catalyst, further wherein the transesterification catalyst comprises a base or a acid.

39. A method of providing a bio-fuel to an engine comprising:
a. providing a bio-substance, a catalyst, and an alcohol to a bio-fuel reactor;
b. exposing the bio-substance to a radio frequency wave for a predetermined amount of time to generate the bio-fuel; and
c. providing the bio-fuel to the engine.

40. The method of claim 39, wherein the bio-substance is an animal fat or an animal oil.

41. The method of claim 39, wherein the bio-substance is a plant or a plant seed oil.
